(19) United States
(12) Patent Application Publication
(10) Pub. No.: US 2008/0307924 A1
(43) Pub. Date: Dec. 18, 2008

(54) Transmission for a Twin-Screw Extruder

(76) Inventor: Erwin Schnabl, Wolkersdorf im Weinviertel (AT)

Correspondence Address: K.F. ROSS P.C., 5683 RIVERDALE AVENUE, SUITE 203 BOX 900, BRONX, NY, 10471-0900, US

(21) Appl. No.: 12/067,296

(22) PCT Filed: Sep. 15, 2006
(86) PCT No.: PCT/EP2006/066413

§ 371 Date: Jul. 8, 2008

(30) Foreign Application Priority Data
Sep. 19, 2005 (AT) A1540/2005

(51) Int. Cl. F16H 37/06

(52) U.S. Cl. 74/665 GD

(57) ABSTRACT

Gear system for driving screws of a twin-screw extruder with two parallel drive shafts (1, 2) of different length, of which the longer drive shaft (1) bears a drive gear wheel (3). The shorter drive shaft (2) has rotationally fixed connection by way of a pinion (6) to three distributor shafts (13, 14, 15), which can be driven from the longer drive shaft (1) by way of an annular gear wheel (20) which has internal teeth (19) and, on the distributor shafts (13, 14, 15), gear wheels (16, 17, 18) intermeshing with these teeth. On the longer drive shaft (1), there is a pinion (5) directly intermeshing with the pinion (6) of the shorter drive shaft (2). In order to achieve good division of the loads, the annular gear wheel (20) also has outer teeth (21) which intermesh with gear wheels (22, 23) of two intermediate shafts (24, 25), which intermesh by way of further gear wheels (26, 27) with the drive gear wheel (3).

### TECHNICAL FIELD

The invention refers to a transmission according to the preamble of claim 1.

### STATE OF THE ART

The problem with driving twin-screw extruders lies in the fact that two drive shafts that are very close to each other have to transfer very high torques. Both drive shafts of the transmission have different lengths. A drive gear of virtually any size can be put on the long drive shaft so that the forces effective on this drive gear (as a result of its large diameter) can be kept within reasonable limits in spite of the high torque. Only a gear with relatively small diameter can be put on the short drive shaft, as it would otherwise interfere with the long drive shaft. The forces on this gear are extremely large with high torque. The pressure on the teeth of the gear can only be mitigated in a limited manner by making the gear longer (longitudinally of the drive shaft), but since the drive shaft will twist at high torque, only one portion of the length of the gear will then actually transmit force. Maximum torque is the result of the force the teeth of the gear are sustaining, that is to say the radial forces the radial bearings can absorb on one hand, and the diameter of the gear on the other hand, which can be transferred to the short drive shaft.

The torques that the screws can withstand are getting increasingly larger as a result of material improvements, so that ever stronger transmissions are called for. To be able to transfer higher torque to the short drive shaft, it has been suggested in AT 351235 to drive the gear of the short drive shaft not with one gear, but with two gears, so that the transferable torque can thus be roughly doubled. Two distributor shafts are intended for this purpose, each meshing on one side with the gear on the short drive shaft and on the other side with the drive gear on the long drive shaft.

It is disadvantageous in this case that both distributor shafts are not in the symmetry plane of the housing, its assembly and disassembly thus being complex.

In order to solve this problem, it has been suggested in AT 398938 [U.S. Pat. No. 4,899,620] to provide only one distributor shaft and to provide a gear on the long drive shaft for the second power train, directly meshing with the gear on the short drive shaft. The gear on the short drive shaft is in turn driven by two gears so that about double torque is transferable herewith.

In published Austrian patent application AT 1690/98 (corresponding to EP 995580 [U.S. Pat. No. 6,318,202]) these two solutions have been combined, that is, it has been suggested to provide two distributor shafts as well as a gear on the long drive shaft directly meshing with the gear on the short drive shaft. This results in three power chains, thus tripling the transferable torque.

It has also been claimed in that patent application to provide three distributor shafts so that the transferable torque is quadrupled. However, no embodiment has been revealed for this, so that it remains unclear how three distributor shafts can be driven uniformly.

In the public appeal regarding the opposition to patent application AT 1690/98 on 15 Jun. 2005, the suggestion was made to drive the three distributor shafts via a ring gear. This is the category-defining state of the art. However, it is not simple to drive three distributor shafts uniformly with one ring gear. If the ring gear's internal teeth are driven by a single gear, very high radial forces result, shifting the ring gear minimally in the bearing and thus relieving at least one distributor shaft (which will then idle). This is the case even if one proceeds on the assumption that the ring gear is an ideal rigid body. Further taking into consideration that the ring gear will deform elastically, the circumstances are even more unfavorable.

### OBJECT OF THE INVENTION

It is the object of the invention to avoid these disadvantages and to provide a transmission of the type mentioned above, where an ideal distribution of torque is ensured.

In accordance with the invention, this is attained with a transmission of the type mentioned defined by the characterizing features of claim 1.

The position of the intermediate shafts can be freely optimized (the distributor shafts are not in the way) by driving of the three distributor shafts via the internal teeth of the ring gear, which in turn can be driven via its external teeth and two intermediate shafts. In addition, the radial forces of both intermediate shafts neutralize each other at least in part. In this manner, shear forces and elastic deformations can largely be avoided. Thus, a very good distribution of torques to be transferred results in the transmission in accordance with the invention, the loads for the individual components being kept low and no excessive tensions having to be permitted in the individual components, even under confined-space conditions. This results in high operating safety of the transmission.

In this context it is particularly advantageous to provide the features of claim 2. Due to these measures, the shear forces occurring during the transfer of torque largely neutralize each other so that the ring gear is hardly moved out of its intended position. The ideal angle between the axial planes of the outer distributor shafts and the axial planes of the intermediate shafts is approximately 20° if the thickness of the ring gear is negligible and increases with the thickness of the ring gear. The ideal angle is thus between 20° and 30°.

In order to be able to better absorb axial forces occurring during extruding by means of the screws, it is advantageous to provide the features of claim 4. Since the teeth of the ring gear are pitched oppositely to each other, the ring gear is subject to no net axial forces.

### BRIEF DESCRIPTION OF THE DRAWING

The invention is now described in detail with reference to the drawings, in which:

FIG. 1 is a schematic view of the transmission in accordance with the invention as seen from the input side;

FIG. 2 is a schematic view of the transmission according to FIG. 1 as seen from the output side;

FIG. 3 shows the transmission according to FIGS. 1 and 2 as seen from the output side, however without the ring gear and intermediate shafts;

FIG. 4 shows the transmission according to FIGS. 1 and 2 as seen from the output side, however without ring gear and intermediate shafts; and

FIG. 5 is a schematic view of the relative positions of the long and the short drive shafts.

### BEST MODE FOR CARRYING OUT THE INVENTION

An input gear 3 is rotationally fixed on a long drive shaft 1, meshing with an unillustrated output gear of a motor, or the long drive shaft 1 is coupled directly with a drive motor. Furthermore, the long drive shaft 1 carries an axial bearing 4 and is rotationally fixed to an output gear 5 that meshes with a gear 6 rotationally fixed to a short drive shaft 2. The short drive shaft 2 also has an axial bearing 9. This is limited in diameter due to the closeness of the long drive shaft 1 and is preferably designed as a double bearing.

The output gears 5 and 6 have helical gear teeth. This helical gearing is selected such that the short drive shaft 2 is pushed toward the respective screw and thus the axial forces working on the bearing 9 of the short drive shaft 2 become proportionally smaller with rising torque. As a result, the axial forces on the long drive shaft 1 do increase, but this is not problematic since the axial bearing 4 can be made larger.

As can be seen from FIG. 5, radial bearings 7 are mounted flanking the output gear 5 on the long drive shaft 1. Radial bearings 8 are mounted offset axially to them on the short drive shaft 2. This axial offset is necessary to be able to make the radial bearings 7 and 8 as big as possible. The spacing of the radial bearings 8 from the output gear 6 is only a slight problem because the radial forces on the gear 6 neutralize each other largely, as will be explained.

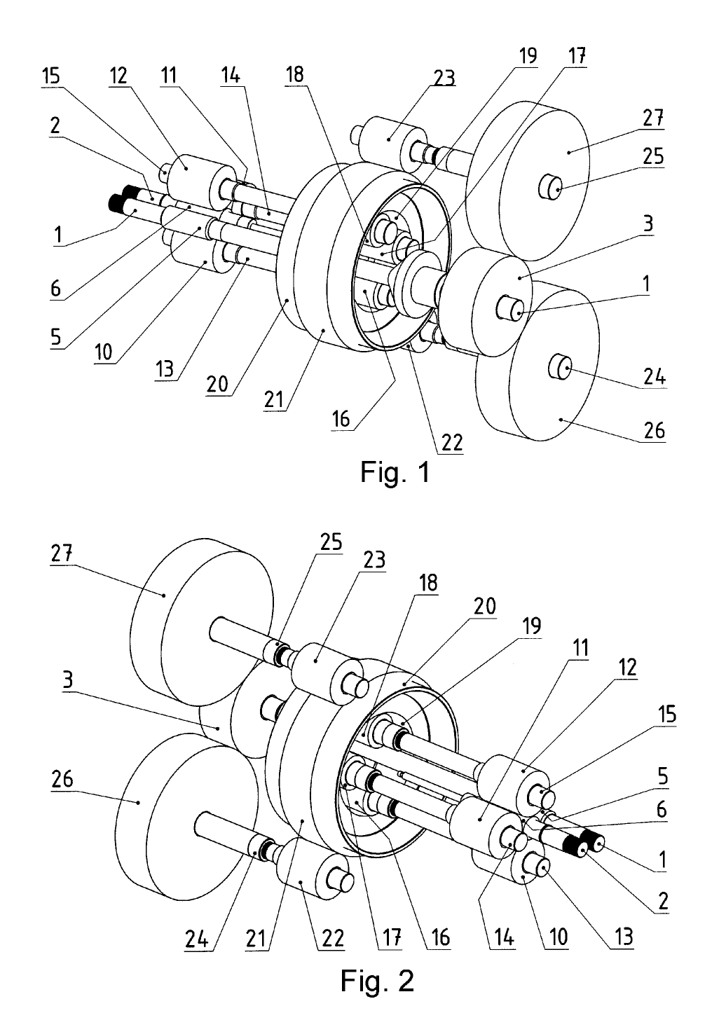

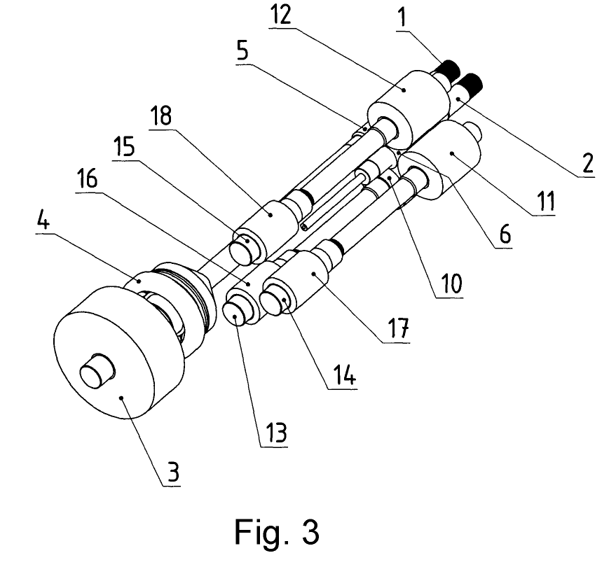

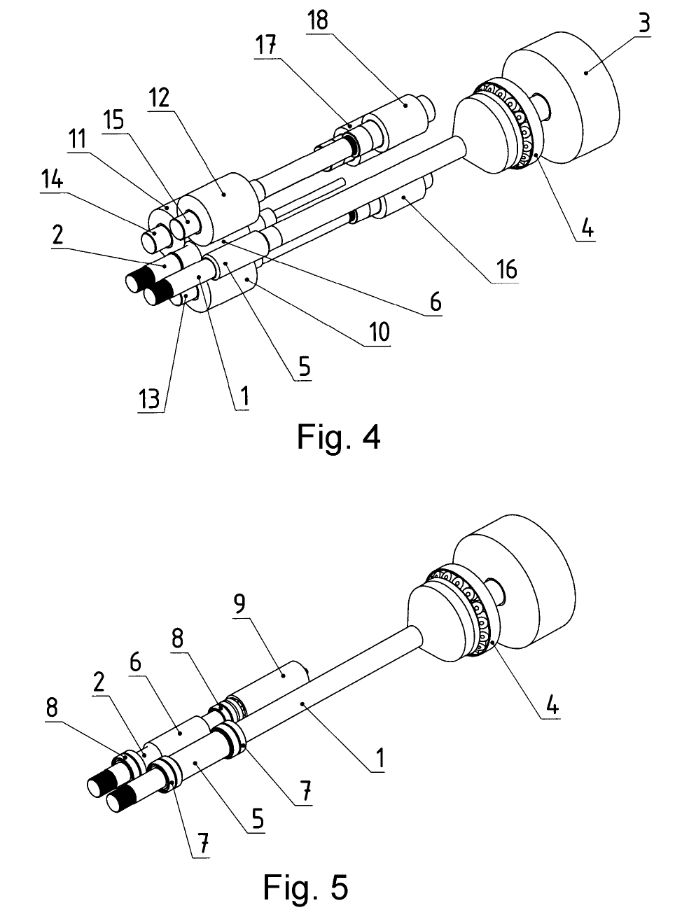

For reasons of improved clarity of view, the bearings 4, 7, 8 and 9 in FIGS. 1 to 4 are shown only in part.

Furthermore, output gears 10, 11, 12 rotationally fixed on respective distributor shafts 13, 14, 15 mesh with the output gear 6 of the short drive shaft 2. Rotationally fixed on these distributor shafts 13, 14, 15 are further input gears 16, 17, 18 meshing with internal teeth 19 of a ring gear 20.

This ring gear 20 is furthermore provided with external teeth 21, the internal teeth 19 and the external teeth 21 being helical with opposite pitches.

The distributor shafts 13, 14 or 14, 15 are angularly spaced by 90°, the long drive shaft 1, the short drive shaft 2 and the middle distributor shaft 14 being coplanar. Thus the output gear 6 is driven by four output gears that are angularly equispaced around it so that their radial forces neutralize each other.

The external teeth 21 of the ring gear 20 mesh with output gears 22 and 23 rotationally fixed on respective intermediate shafts 24 and 25. Further input gears 26 and 27 rotationally fixed on these intermediate shafts 24 and 25 mesh with the input gear 3.

The intermediate shafts 24 and 25 are offset from the distributor shaft 14 relative to the axis of the short drive shaft by an angle of 20°-30° relative to the distributor shafts 13, 15 in order to keep the ring gear 20 largely free from transverse forces. A uniform allocation of torque on the distributor shafts 13, 14, 15 is thus achieved.

All the gears are—in a known manner—designed as helical gears in order to partially compensate for axial forces transferred to the short drive shaft from the corresponding screw and thus take load off the axial bearing 9, which is limited in diameter.

Due to the design of the transmission according to FIGS. 1 to 5, the loads on the individual gears and shafts are kept low so that high torques can be transferred via the transmission to the screws of both the drive shafts 1 and 2. Thus the high load-bearing capacity of the screws can be utilized fully without the danger of failure of the transmission.

1. A transmission for driving the screws of a twin-screw extruder comprising two parallel drive shafts of different length rotating opposite to each other and connected with the respective screws, the long drive shaft carrying a drive gear, the short drive shaft being rotationally fixed to a gear connected to three distributor shafts that can be driven from the long drive shaft by a ring gear having internal teeth and, on the distributor shafts, gears meshing with these internal teeth, the long drive shaft carrying a gear directly meshing with the gear of the short drive shaft wherein the ring gear is provided with external teeth meshing with gears of two intermediate shafts meshing via further gears with a drive gear.

2. The transmission according to claim 1 wherein there are the three distributor shafts angularly spaced at approximately 90° and the intermediate shafts are in axial planes and between axial planes of the outer and the center distributor shafts.

3. The transmission according to claim 2 wherein the angle between the axial planes of the outer distributor shafts and the axial planes of the intermediate shafts is 20°-30°.

4. The transmission according to claim 1 wherein the gears, in a known manner, have helical gearing, the internal teeth and the external teeth of the ring gear being pitched oppositely to each other.

5. A drive transmission for a twin-screw extruder, the transmission comprising:
a long drive shaft connectable directly to one of the screws, and carrying an input gear and an output gear;
a short drive shaft parallel to the long drive shaft, connectable directly to the other of the extruder screws, and carrying a gear directly meshing with the long-shaft output gear;
a ring gear having internal teeth and external teeth;
three distributor shafts having respective input gears meshing with the internal teeth of the ring gear and respective output gears meshing with the short-shaft gear; and
two intermediate shafts having respective output gears meshing with the external teeth of the ring gear and input gears meshing with the long-shaft input gear.

6. The drive transmission defined in claim 5 wherein the transmission is centered on a center axis substantially parallel to all of the shafts, the distributor shafts being angularly offset from each other by about 90° about the center axis, the intermediate shafts being angularly offset from each other also by about 90° and being angularly interleaved with the distributor shafts with each intermediate shaft being centered on an axis angularly flanked by the axis of the center distributor shaft and the axis of a respective one of the outer distributor shafts.

7. The drive transmission defined in claim 6 wherein each of the outer distributor shafts is offset angularly by between 20° and 30° from the axis of the respective intermediate shaft.

8. The drive transmission defined in claim 5 wherein the internal and external teeth of the ring gear are helical and of opposite pitch.

9. The drive transmission defined in claim 5 wherein all of the gears are helical-tooth gears.
